(19) United States
(12) Patent Application Publication
(10) Pub. No.: US 2017/0147974 A1
(43) Pub. Date: May 25, 2017

(54) SYSTEMS AND METHODS OF CONTROLLING DELIVERY OF PRODUCTS

(71) Applicant: Wal-Mart Stores, Inc., Bentonville, AR (US)

(72) Inventors: Subodh K. Pandey, Bentonville, AR (US); Suyog Barve, Rogers, AR (US); Swati Tripathi, Bentonville, AR (US)

(21) Appl. No.: 15/354,232

(22) Filed: Nov. 17, 2016

Related U.S. Application Data
(60) Provisional application No. 62/258,315, filed on Nov. 20, 2015.

(51) Int. Cl. G06Q 10/08

(52) U.S. Cl. CPC G06Q 10/0832; G06Q 10/0833

(57) ABSTRACT

In some embodiments, systems, apparatuses and methods are provided herein that provide control over the delivery of products. In some embodiments, a product delivery control system comprises: a customer authorization system configured to receive, from a customer who ordered a product, an authorization to associate one of one or more delegates, designated by the customer, to receive products on behalf of the customer; a delegate tracking system configured to identify when a first delegate of the one or more delegates is within a geographic threshold distance of an originally specified receiving location where the product ordered by the customer is scheduled to be received; and a delivery authorization system configured to communicate an authorization to a first user interface unit associated with the first delegates that authorizes the first delegate to receive the product at the receiving location on behalf of the customer.

### CROSS-REFERENCE TO RELATED APPLICATION

This application claims the benefit of U.S. Provisional Application No. 62/258,315, filed Nov. 20, 2015, and is incorporated herein by reference in its entirety.

### TECHNICAL FIELD

This invention relates generally to product deliveries.

### BACKGROUND

In a modern retail environment, there is a need to improve the customer service and/or convenience for the customer. One aspect of customer service is the delivery of products. There are numerous ways to deliver products to customers. The delivery of products can result in undesirable delays, can add cost, and reduce revenue.

### BRIEF DESCRIPTION OF THE DRAWINGS

Disclosed herein are embodiments of systems, apparatuses and methods pertaining to controlling the delivery of products. This description includes drawings, wherein:

FIG. 1 illustrates a simplified block diagram an exemplary product delivery control system, in accordance with some embodiments.

FIG. 2 illustrates a simplified flow diagram of a process of controlling product deliveries, in accordance with some embodiments.

FIG. 3 illustrates an exemplary system for use in implementing systems, apparatuses, devices, methods, techniques and the like in controlling the delivery of products in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of exemplary embodiments. Reference throughout this specification to “one embodiment,” “an embodiment,” “some embodiments”, “an implementation”, “some implementations”, or similar language means that a particular feature, structure, or characteristic described in connection with the embodiment is included in at least one embodiment of the present invention. Thus, appearances of the phrases “in one embodiment,” “in an embodiment,” “in some embodiments”, “in some implementations”, and similar language throughout this specification may, but do not necessarily, all refer to the same embodiment.

Generally speaking, pursuant to various embodiments, systems, apparatuses and methods are provided herein useful to deliver products to customers. In some embodiments, product delivery control systems are provided that include a customer authorization system configured to receive, from a customer who ordered a product, an authorization to associate one of one or more delegates, designated by the customer, to receive products on behalf of the customer. A delegate tracking system cooperate with the product delivery control system and be configured to identify when a delegate of the one or more delegates is within a geographic threshold distance of an originally specified receiving location where the product ordered by the customer is scheduled to be received. Some embodiments include a delivery authorization system that communicates an authorization to a user interface unit associated with the delegate that authorizes the delegate to receive the product at the receiving location on behalf of the customer.

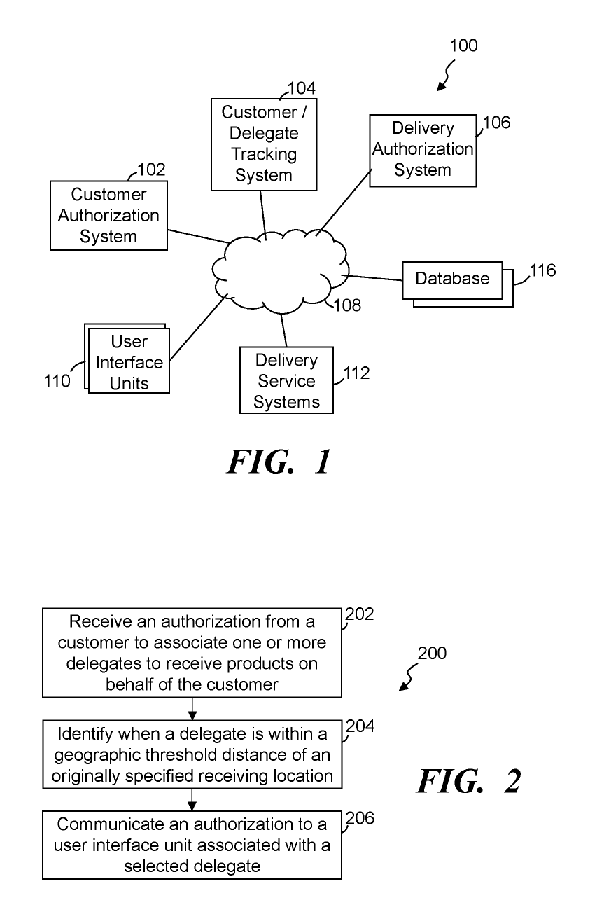

FIG. 1 illustrates a simplified block diagram of an exemplary product delivery control system 100, in accordance with some embodiments. The delivery control system includes one or more customer authorization systems 102, one or more customer and/or delegate tracking systems 104 (generally referred to as delegate tracking systems below for simplicity), and one or more delivery authorization systems 106, which are communicatively coupled over one or more distributed communication networks 108 (e.g., LAN, WAN, Internet, cellular, Wi-Fi, other such communication networks or combination of two or more of such networks). Typically, the delivery control system 100 further includes and/or is in communication with multiple portable and non-portable user interface units 110 (e.g., smart phones, tablets, computers, laptops, optical head-mounted display systems, smart watch systems, delivery driver specific wireless communication devices, shopping facility specific wireless communication devices, scanning devices, and other such user devices). Some embodiments may additionally include and/or communicate with one or more delivery service systems 112, one or more databases 116, and the like. The delivery control system 100 may include and/or communicate with one or more other systems, such as but not limited to an inventory system of a shopping facility, distribution center, shipping facility, and the like; a purchase order system of a shopping facility, on-line retailer, third party service, and the like; and other such systems. While FIG. 1 illustrates that the customer authorization system 102, the delegate tracking system 104 and the delivery authorization system 106 as separate components, it is understood that two or more of the customer authorization system 102, the delegate tracking system 104 and the delivery authorization system 106 may be incorporated through a single system, and in some instances are cooperated into a single central control system.

The customer authorization system 102 receives, over the communication network 108, an authorization from a customer who has ordered a product to associate one or more separate delegates to receive products on behalf of the customer. A delegate is another person that a customer is willing to have receive and/or pick up a product on behalf of the customer. The authorization may be received at the time the customer orders a product, at some time prior to the product being received and/or delivered, at a time a customer registers to participate in a service through a retail entity (e.g., a retail store, a chain of retail stores, an on-line retail service, other such retail entities, or combinations of such retail entities) that allows delegates to receive products on behalf of customers, at a time of registering with a retail entity (e.g., to obtain an account, participate in purchase discount programs, etc.), in response to a request to be delegate for another person, or the like. In some embodiments the customer authorization system 102 and/or a separate customer profile system maintains customer information, such as in one or more profiles, of a variety of information (e.g., name, contact information (e.g., phone number/s, email address/es, etc.), one or more shipping addresses, billing address/es, payment methods, user interface unit identifier information (e.g., phone number, serial number, user specified identifier, etc.), preferences, shopping history, purchase history, related customers, delegate identifiers, other such information, and typically a combination of two or more of such information). The customer can specify a delegate and/or select from a listing of potential delegates. In some embodiments, some or all of the customer information may be stored in the customer authorization system 102, one or more databases 116, other such data storage systems or devices, or two or more of such systems.

The customer can establish a trusted network of one or more delegates that the customer may authorize to receive a package for the customer. Delegates can be family members, friends, co-workers, or others that the customer is willing to authorize as a delegate. The customer may enter information that allows the customer authorization system 102 and/or delegate tracking system 104 to identify a potential delegate (e.g., a name of a delegate, an email address, a phone number, etc.). Additionally or alternatively, a customer's user interface unit may utilize a customer's contact information and/or other social network contact information, and communicate some or all of this information to the delivery control system 100 which can then generate a listing of potential delegates (e.g., potential delegates that have previously registered with the delivery control system or a corresponding retail entity associated with the delivery control system). Further, in some applications, the delivery control system may use the contact information and request authorization to contact one or more of the contacts regarding whether one or more of these contacts would be willing to participate as a potential delegate. In some embodiments, a potential delegate is contacted by the delivery control system to obtain authorization from the potential delegate that she or he is willing to be a delegate for the customer. Further, the delivery control system may preclude one or more potential people from being considered by a customer as a potential delegate (e.g., based on customer profile information where a user has specified they do not want to be considered as a delegate or not considered as a delegate for one or more other people and/or people that the user has not already designated). In some applications, when a customer authorizes another person to be his or her delegate, that customer may also become a delegate of the other person. In some embodiments, when the customer is registering to authorize a delegate, the customer will be provided with one or more options that allow the customer to customize the use of at least some aspects of the delegate association and/or assignment. These options can include, but are not limited to, one or more levels of trust (e.g., trust to receive any product, trust to receive products worth less than a selected threshold, selection of one or more products and/or types of products a delegate may receive and/or should not be considered to receive (e.g., pharmaceuticals, liquor, personal products, etc.), whether the customer is willing to reciprocate and be a delegate, and other such options. Further, a customer may designate priorities of different potential delegates. For example, the customer may designate a spouse as a highest priority potential delegate, one or more children as second priority delegate, a first set of one or more friends at a third priority, a second set of one or more friends at a fourth priority, a first set of one or more select neighbors and/or select co-workers at a fifth priority, a second set of one or more other select neighbors and/or co-workers at a sixth priority, and the like. Similarly, the priority of delegates may be different for different types of products, based on a delivery service, based on a receiving location, and/or other such factors.

The use of delegates can allow a product to be received and/or delivered even when the customer is not available or not at the receiving location. This can be advantageous at least when the receiving location is a shopping facility and the customer is not at the shopping facility. For example, a customer may order and/or purchase one or more products on-line with the intent of picking the one or more products up at a shopping facility. When it is determined a delegate is at the shopping facility or associated shopping facility at the time the order is received, and/or a delegate goes to the shopping facility or associated shopping facility prior to the customer, the delivery control system 100 can recognize the delegate is available and allow the customer to authorize the delegate to receive the one or more products on behalf of the customer. This can save the customer the trip of going to the shopping facility.

As another example, a product may be scheduled to be delivered to a receiving location (e.g., a customer's home, a customer's place of work, etc.). However, the customer may not be available at the time the product is to be delivered (e.g., the customer is stuck in a meeting or traffic and cannot be available) to receive the product. By designating a delegate the customer can authorize the delegate to receive the product on behalf of the customer. Further, some embodiments determine a location of one or more delegates in determining whether the delegate is a viable delegate. Deliveries are typically scheduled to occur and product allocation, shipment and sorting have to occur prior to a delivery. Further, a delivery vehicle is typically scheduled to deliver more than one package. Additionally, it is particularly difficult to modify a scheduled delivery location within a threshold period of time of the scheduled delivery time because this can dramatically alter a delivery driver's course. Accordingly, some embodiments limit the selection of a delegate to those delegates that are at the prescheduled delivery location or are within a threshold distance of the scheduled delivery location. This allows deliveries to be scheduled, routes of deliveries optimized, and allows the delivery personnel to go to the intended delivery location and does not have to alter the delivery route. Further, the use of the delegate allows more packages to be delivered and reduces the number of packages that might otherwise have to be taken back to a delivery service's location and rescheduled for delivery.

The delegate tracking system 104 is configured to receive location information corresponding to people that have agreed to be delegates for one or more other customers, and use the location information to determine a relative position of one or more delegates relative to a scheduled receiving location when a customer requests that a delegate receive a product on behalf of the customer. Further, in some instances, the delegate tracking system may track relative movements of one or more delegates and/or customers relative to predefined locations (e.g., scheduled delivery locations, retail facility locations, and the like). The delegate tracking system 104 is configured to receive location information corresponding to people that have agreed to be delegates for one or more other customers, and use the location information to determine a relative position of one or more delegates relative to a scheduled receiving location when a customer requests that a delegate receive a product on behalf of the customer. Further, in some instances, the delegate tracking system may track relative movements of one or more delegates and/or customers relative to predefined locations (e.g., scheduled delivery locations, retail facility locations, and the like).

The delegate tracking system may periodically receive location information without requesting the information, such as a software application (APP) implemented on portable user interface units may cause the user interface units to communicate location information (e.g., global positioning information, antenna information, antenna triangulation information, movement sensor information, and the like) to the delegate tracking system 104; periodically based on a schedule; in response to a request from the delegate tracking system; and the like. Further, when a schedule dictates the rate at which location information is communicated from the user interface unit, the schedule may in some instances be a variable schedule and/or may be adjusted in response to instructions from the delegate tracking information. In some applications, the delegate tracking system may cause more or less frequent communications of the location information based on one or more factors, such as but not limited to a relative location and/or current route of travel relative to a product receiving location, a current location or route of travel relative to a location of a customer, and the like. Additionally or alternatively, the location information may be received in response to a request from the delegate tracking system.

In some embodiments, the location information may be received directly from a delegate or customer, for example, based on a response to an email, text message, notice through a software application (APP) implemented on a user interface unit, or the like. Additionally or alternatively, the location information may be received by cellular communication, Wi-Fi communication, via the Internet, and/or other such communication techniques. In some applications, a delegate's and/or customer's portable user interface unit 110 may communicate location information to the delegate tracking system 104. The location information may include global positioning satellite (GPS) coordinate information, antenna information, antenna triangulation information, Wi-Fi identifier information, movement tracking information, and/or other such information. For example, an APP corresponding to a retailer and/or a delivery service and operated on a user interface unit may cause the user interface unit to communicate the location information (e.g., via a cellular communication). The request for location information and/or a trigger communicated to the user interface unit to periodically provide location information (or provide location information based on a schedule, etc.) may be initiated in response to receiving a notice from a customer that the customer is not going to be available to receive the product/s. As such, the delegate tracking system may not, in some applications, continually track a delegate's and/or customer's location and/or cause a user interface unit associated with a delegate to continually provide location information. Instead, the delegate tracking system may limit obtaining and/or tracking location information of one or more delegates and/or customers after receiving a notice that a customer is not going to be available. The acquisition and/or tracking of location information is typically further limited to those delegates in a trusted network of the customer who is requesting that a delegate potentially receive a product or package. In other instances, the location of one or more delegates may automatically be tracked for one or more potential delegates associated with a customer scheduled to receive a product (e.g., in response to receiving an order for a customer to pick up a product at a retail store to determine whether one or more potential delegates are at or near the selected retail store or an associated retail store that can supply the product, at a threshold time prior to a scheduled delivery, etc.). In still other instances, the delegate tracking system may periodically receive location information corresponding to those people that have agreed to be a delegate for one or more other customers, and store that information for later use in the event a delegate is potentially needed. Further, the periodic location information may be used to disregard a potential delegate (e.g., based on the previous location information indicating the delegate is a threshold distance away from a receiving location).

Additionally or alternatively, an APP operating on a user interface unit corresponding to a person that has agreed to be a delegate may detect when the user interface unit enters a predefined geographic area and/or passes one or more geographic boundaries, and in response communicates a notification to the delegate tracking system that the user interface unit is in the predefined geographic area and/or communicates location information.

In some embodiments, the delegate tracking system 104 repeatedly receives over time global positioning information and/or other such location information from one or more user interface units associated with each of the previously designated delegates. Using this global position information and/or other location information, the delegate tracking system can identify one or more user interface units, based on the global positioning information, that are within the geographic threshold distance of the receiving location at a time corresponding to when the product is to be received. This time, in some instances, includes a threshold period of time corresponding to a scheduled delivery time and/or within a threshold period of time when a delivery is predicted to occur (e.g., based on a current location of a delivery vehicle, number of deliveries prior to the delivery of interest, traffic conditions, historic travel times, historic times to delivery packages, and/or other such factors).

As indicated above, in some implementations, the delegate tracking system identifies a delegates location and/or tracks their location in response to an indication a customer is not available to retrieve the product and/or does not anticipate being available at a scheduled delivery time or at a time when a delivery is occurring. For example, the delivery authorization system may receive a notification that the customer is not going to be available at the receiving location to retrieve the product. This notification may be in response to a delivery driver contacting the customer with an estimated delivery, based on a prescheduled delivery time or the like. The delegate tracking system can, in response to receiving the notification that the customer is not going to be available at the receiving location to retrieve the product, identify one or more delegates associated with the customer (typically based on one of the one or more delegates that the customer has previously or currently identified). The most recent global positioning information, of the global positioning information received over time, from one or more user interface units corresponding to at least one of the identified delegates, can be evaluated relative to the receiving location.

In some embodiments the delivery control system 100 further notifies the customer that a delegate is available after receiving an acknowledgment from delegate that the delegate is willing to receive the product on behalf of the customer. The delegate tracking system, in some applications, communicates a request to one or more potential delegate associated with the customer, and requests an acknowledgment that a delegate is willing to receive the product on behalf of the customer. Further, the delegate tracking system may notify the customer that at least one of the delegates is within the geographic threshold of the receiving location in response to receiving an acknowledgement from a delegate that the delegate is willing to receive the product on behalf of the customer.

The delivery authorization system 106 receives a notification that a customer has authorized a delegate to receive the product on behalf of the customer. This notification can be communicated directly to the delivery authorization system from a customer's user interface unit, received through the customer authorization system, or the like. In some applications, the delivery authorization system may communicate a reminder and/or confirmation to the customer regarding receiving the product. This reminder may allow a customer to acknowledge a scheduled delivery, acknowledge a receiving location, notify the delivery control system 100 that the customer is unavailable, request a delegate be authorized, select and authorize a delegate from one or more potential delegates (e.g., listing of potential delegates), and/or other such options. In some instances, the one or more potential delegates may be identified by the delegate tracking system 104 based on location information relative to a receiving location. Additionally or alternatively, the customer may communicate directly with a potential delegate. In such instances, the customer may request an authorization code or other such authorization verification from the delivery authorization system be communicated to the customer's user interface unit, and the customer can forward that authorization to the delegate. The delivery authorization system may further be notified. For example, the customer may communicate through and APP to a potential delegate requesting the delegate receive the product. Further, the customer can receive the authorization through the APP and/or communicate the authorization through the APP to the selected delegate. The APP can further notify the delivery authorization system of the transfer of the authorization, and in some instances at least an identifier of the delegate. Once a request is received from the customer and/or a delegate is selected, the delivery authorization system can communicate an authorization to a user interface unit associated with the delegate that authorizes the delegate to receive the product at the receiving location on behalf of the customer.

In some embodiments, a notification that the customer is not going to be available at the receiving location at a scheduled delivery time to retrieve the product may be received by the delivery authorization system 106. In response, the delivery authorization system may identify one or more user interface units corresponding to one or more delegates associated with the customer that are with a geographic threshold distance of the receiving location. For example, the receiving location may be at a shopping facility or any one of multiple different shopping facilities, and the delegate tracking system may identify one or more delegates that are in the shopping facility and/or within a geographic threshold distance of the shopping facility. The customer authorization system, delegate tracking system or the delivery authorization system may notify the customer that at least one of the one or more delegates designated by the customer is within the geographic threshold of a selected shopping facility or an associated shopping facility (e.g., another retail store of a chain of retail stores).

In another example, the receiving location may be at specified delivery address, such as a customer's place of work, home or other location. As such, the threshold distance may be a limited geographic distance and/or a predicted time of travel from the receiving location (e.g., from a customer's place of work, and one or more delegates may be co-workers). In some embodiments, the delegate tracking system identifies, when the receiving location is at a scheduled delivery address where a delivery vehicle is scheduled to deliver the product, whether a delegate is within the geographic threshold distance of the scheduled delivery address. The delivery authorization system can communicate the authorization to a user interface unit 110 associated with a delegate that authorizes the delegate to receive the product in response to receiving the notification that the customer is not going to be available at the receiving location and the user interface unit is within the geographic threshold distance of the scheduled delivery address. In some applications, a potential delegate receives a notification that a customer is looking for someone to be her or his delegate, and the potential delegate can select an option through the APP agreeing to be a delegate. The APP can communicate the acceptance, and may initiate a token transfer to get an authorization code. The delivery authorization system receives the token and generates and communicates the delivery authorization to the user interface unit and/or the delegate. The authorization may be encrypted and/or other protections may be applied to inhibit unauthorized use of the authorization. A delivery service and/or a shopping facility may also receive a notification that the authorization (e.g., certificate, key, passcode, etc.) has been communicated to the assigned delegate.

In some instances, the customer is not provided with an identification of the one or more potential delegates that are within the threshold distances, and typically is prevented from receiving identification information of a potential delegate until after the delegate agrees to receive the product. This maintains some privacy for delegates and limits a customer from being able to track potential delegates' locations. The customer can be notified of an identification of a selected delegate after the delegate has agreed to receive the product. Still further, those individuals that have agreed to be a delegate may temporarily remove themselves for consideration as a delegate for one or more potential other people with whom that have previously agreed to be a delegate. For example, the APP may provide a user with an option to activate a privacy option that prevents the user interface unit from communicating location information to the delegate tracking system 104, an option to indicate the user is temporarily unavailable as a delegate, an option that lists those people for whom the user has agreed to be a delegate and an option corresponding to each of the people listed allowing the user to temporarily indicate they are not available as a potential delegate for that correspondingly listed person, and other such options. Additionally or alternatively, an APP on the potential delegate's user interface unit 110 and/or the delegate tracking system 104 may obtain information from a person's digital calendar and/or other application, and can use information from the calendar or other application to identify when a user is not available (e.g., based on a scheduled meeting, a “busy” status indication, or the like). As such, the APP and/or the delegate tracking system may synchronize with the user's calendar and/or other application in evaluating whether a user should be considered as an available delegate and/or whether location information should be communicated to the delegate tracking system or considered by the delegate tracking system.

Still further, a user that has previously agreed to be a delegate for another person may agree on a single time bases and/or may permanently remove themselves as a potential delegate for one or more other people. The APP on the user interface unit may allow the user to modify one or more profile options, which can include whether to continue to be considered as a delegate for one or more other people. Additionally or alternatively, the user may access a user profile and/or delegate profile, and modify one or more options. One of those options may be to permanently remove themselves as a potential delegate for one or more other people.

In some embodiments, the delivery authorization system 106 further notifies delivery personnel and/or a delivery service associated with a delivery vehicle that the delegate is authorized to receive the product at the original receiving location on behalf of the customer. The notice may further information the delivery personnel and/or service that an authorization has been communicated to the user interface unit associated with the designated delegate. Accordingly, the delivery personnel can request to visually view the authorization through the delegate's user interface unit, scan one or more aspects of the authorization displayed through the user interface unit (e.g., scan a bar code), and/or have the user interface unit communicate something to a user interface unit associated with the delivery personnel. This can provide some added security in attempts to ensure the accurate delegate receives the product. The delivery personnel may additionally obtain a signature or other confirmation from the delegate that the delegate actually received the product.

In some embodiments, the delivery service may activate the delegate tracking system and/or delivery authorization system to determine whether a delegate is available. For example, a delivery person may be at a scheduled delivery location and the customer may not be present or available. Accordingly, the delivery person may communicate from the delivery person's user interface unit (which may be a specific device for the delivery service) requesting whether a delegate can receive the package. Some applications may limit the delivery service's ability to implement this action through the customer authorization system, where the customer can set one or more options relative to the delivery service's ability to initiate a potential delegate delivery (e.g., whether the delivery service can initiate a delivery through a delegate; types of products, sources of products, and/or value of products for which the delivery service can initiate a potential delegate delivery; limit the potential delegates that may be considered from a delivery service initiated delegate delivery; and the like). In some implementations, the customer may be notified of the delivery person trying to initiate the delegate delivery, and provided an opportunity to authorize or prevent the delegate delivery.

FIG. 2 illustrates a simplified flow diagram of a process 200 of controlling product deliveries, in accordance with some embodiments. In step 202, an authorization is received from a customer who ordered a product to associate one of one or more delegates, designated by the customer, to receive products on behalf of the customer. Again, this designation may occur when the customer registers to participate in the delegate receiving service, at the time of ordering a product, etc. In step 204, it is determined and/or the system identifies when at least one delegate (e.g., a first delegate) of the one or more delegates is within a geographic threshold distance of an originally specified receiving location where the product ordered by the customer is scheduled to be received. As described above, the receiving location may be a store where a customer intends to pick up a product, any one of multiple different associated stores where the customer can pick up the product, a predefined delivery location (e.g., customer's home, customer's place of work, etc.), and/or other such predefined receiving locations.

In step 206, an authorization is communicated to a user interface unit associated with a selected delegate (e.g., the first delegate). The authorization authorizes the delegate to receive the product at the receiving location on behalf of the customer. In some instances, the authorization is used by the delegate to prove they have been authorized to receive the product. The authorization may be in the form of a unique bar code that can be scanned, a key that can be electronically communicated (e.g., Wi-Fi, Bluetooth, cellular), a passcode that can be entered, other such authorizations, or combination of two or more of such authorizations.

Some embodiments receive global positioning information from potential delegates' user interface units. For example, global positioning information may be repeatedly received over time from user interface units associated with each of the one or more previously designated delegates. In identifying that a delegate is within the threshold distance, the delegate tracking system can further identify one or more user interface units, based on the global positioning information, that are within the geographic threshold distance of the receiving location at a time and/or within a threshold time corresponding to when the product is to be received. The global positioning information may be evaluated in response to a notification that a customer is unavailable. The notification can be received that the customer is not going to be available at the receiving location at a scheduled delivery time to retrieve the product. One or more delegates can be identified as being associated with the customer as one of the one or more delegates. One or more most recent global positioning information, of the global positioning information received over time, can be evaluated from the one or more potential delegates' user interface units and/or a selected delegate's user interface unit relative to the receiving location in response to receiving the notification that the customer is not going to be available at the receiving location to retrieve the product and that the one or more delegate is associated with the customer as one of the one or more delegates.

In some embodiments, a notification is received that the customer is not going to be available at the receiving location to retrieve the product. The authorization can be communicated to the user interface unit associated with the selected delegate in response to receiving the notification that the customer is not going to be available at the receiving location and the user interface unit associated with the selected delegate is within the geographic threshold distance of the receiving location. In some instances, the receiving location may be a retail store. Accordingly, some embodiments identify, when the receiving location is at a shopping facility from which the customer requested a product be retrieved, that a delegate is within the geographic threshold distance of the shopping facility. The customer can be notified that at least one of the one or more delegates designated by the customer is within the geographic threshold of the shopping facility. Again, the customer typically is not provided with an identification of the potential delegate until the delegate agrees to receive the product or products on behalf of the customer. Instead, the delivery control system 100 can notify the customer that one or more of the potential delegates is within the threshold distance and the request confirmation that the customer would like the system to determine whether the potential delegate would be willing to receive the product on behalf of the customer. After the delegate agrees, the customer can be notified of the delegate's identity.

Similarly, the receiving location may be a preselected delivery address (e.g., home, office, etc.). The delivery control system 100 can identify, when the receiving location is at a scheduled delivery address where a delivery vehicle is scheduled to deliver the product, that the selected delegate is within the geographic threshold distance of the scheduled delivery address. A notification can be communicated to the customer that at least one of the one or more delegates designated by the customer is within the geographic threshold of the scheduled delivery address. Further, a delivery service can be notified of the selected delegate's authorization to receive the package. As such, the delivery control system 100 can notify delivery personnel associated with the delivery vehicle that the selected delegate is authorized to receive the product at the originally specified receiving location on behalf of the customer and that the authorization has been communicated to a user interface unit associated with the selected delegate. In some embodiments, a request is communicated to at least a first delegate requesting an acknowledgment that the delegate is willing to receive the product on behalf of the customer. The customer can be notified that at least one of the one or more delegates is within the geographic threshold of the receiving location in response to receiving an acknowledgement from the delegate that the delegate is willing to receive the first product on behalf of the customer.

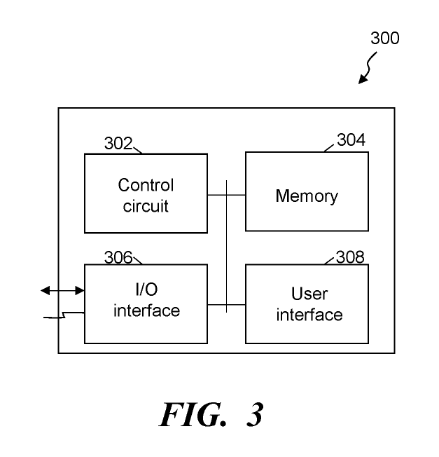

The methods, techniques, systems, devices, services, servers, sources and the like described herein may be utilized, implemented and/or run on many different types of devices and/or systems. Referring to FIG. 3, there is illustrated a system 300 that may be used for any such implementations, in accordance with some embodiments. One or more components of the system 300 may be used to implement any system, apparatus or device mentioned above or below, or parts of such systems, apparatuses or devices, such as for example any of the above or below mentioned customer authorization system 102, customer and/or delegate tracking system 104, delivery authorization system 106, user interface units 110, delivery service systems 112, and the like. However, the use of the system 300 or any portion thereof is certainly not required.

By way of example, the system 300 may include one or more control circuits 302, memory 304, and input/output (I/O) interfaces and/or devices 306. Some embodiments further include one or more user interfaces 308. The control circuit 302 typically comprises one or more processors and/or microprocessors. The memory 304 stores the operational code or set of instructions that is executed by the control circuit 302 and/or processor to implement the functionality of the customer authorization system 102, delegate tracking system 104, delivery authorization system 106, user interface units 110, delivery service systems 112, and the like. In some embodiments, the memory 304 may also store some or all of particular data that may be needed to track product orders, obtain delegate designations and delegate information, register customers, track locations of delegates and/or customers, authorize delegates, and make any of the associations, determinations, measurements and/or communications described herein. Such data may be pre-stored in the memory, received from an external source, be determined, and/or communicated to the system.

It is understood that the control circuit 302 and/or processor may be implemented as one or more processor devices as are well known in the art. Similarly, the memory 304 may be implemented as one or more memory devices as are well known in the art, such as one or more processor readable and/or computer readable media and can include volatile and/or nonvolatile media, such as RAM, ROM, EEPROM, flash memory and/or other memory technology. Further, the memory 304 is shown as internal to the system 300; however, the memory 304 can be internal, external or a combination of internal and external memory. Additionally, the system typically includes a power supply (not shown), which may be rechargeable, and/or it may receive power from an external source. While FIG. 3 illustrates the various components being coupled together via a bus, it is understood that the various components may actually be coupled to the control circuit 302 and/or one or more other components directly.

Generally, the control circuit 302 and/or electronic components of the system 300 can comprise fixed-purpose hard-wired platforms or can comprise a partially or wholly programmable platform. These architectural options are well known and understood in the art and require no further description here. The system and/or control circuit 302 can be configured (for example, by using corresponding programming as will be well understood by those skilled in the art) to carry out one or more of the steps, actions, and/or functions described herein. In some implementations, the control circuit 302 and the memory 304 may be integrated together, such as in a microcontroller, application specification integrated circuit, field programmable gate array or other such device, or may be separate devices coupled together.

The I/O interface 306 allows wired and/or wireless communication coupling of the system 300 to external components and/or or systems. Typically, the I/O interface 306 provides wired and/or wireless communication (e.g., Wi-Fi, Bluetooth, cellular, RF, and/or other such wireless communication), and may include any known wired and/or wireless interfacing device, circuit and/or connecting device, such as but not limited to one or more transmitter, receiver, transceiver, etc.

The user interface 308 may be used for user input and/or output display. For example, the user interface 308 may include any known input devices, such one or more buttons, knobs, selectors, switches, keys, touch input surfaces, audio input, and/or displays, etc. Additionally, the user interface 308 include one or more output display devices, such as lights, visual indicators, display screens, etc. to convey information to a user, such as but not limited to customer information, delegate information, product orders, product information, receiving location information, delivery information, communication information (e.g., text messages, emails, etc.), status information, mapping information, operating status information, notifications, errors, conditions, and/or other such information. Similarly, the user interface 308 in some embodiments may include audio systems that can receive audio commands or requests verbally issued by a user, and/or output audio content, alerts and the like.

Some embodiments may further include one or more location detection systems (e.g., user interface units and/or delivery vehicle systems) may determine and/or track location information, which may be communicated to one or more other systems (e.g., to the delegate tracking system 104). Further, some embodiments may include sensors and/or sensor systems, such as but not limited to inertial detection systems, signal strength detection systems, and the like.

Often, products and/or packages ordered by customers need to be received by a customer and/or signed for by a customer. However, in many instances a customer may not be available to personally receive and/or sign for the package (e.g., customers are at work, do not have someone at home, etc.). As such, people often have to either manage their workhours to accommodate the pickup or have to wait for several attempts to receive it, can expecting the customer to be at a receiving location and available can be a constraint to customer satisfaction. Some embodiments, however, provide customers with alternatives to receive products, and in some applications provides customers with choices regarding receiving products. For example, in some embodiments, a shipment carrier company and/or delivery service can employ applications on user interface units and/or delivery vehicle systems to provide notification of a delegate delivery service. The customer may activate the delegate delivery service, and/or the delivery service may in some instances initiate the delegate service. The delegate service can reduce or eliminate the constraint of being at a receiving location to receive a package, and provide added convenience to customers, and provide more likely delivery of ordered products. Similarly, with orders to be picked up at a store, customers have the flexibility to choose an authorize delegate who is available and in proximity to (e.g., a threshold distance to) the store to receive the ordered one or more products on behalf of the customer, and thus saving the customer time, travel and money.

In some embodiments, systems, apparatuses and methods are provided to control the delivery of products. In some embodiments, a product delivery control system is provided that comprises: a customer authorization system configured to receive, from a customer who ordered a product, an authorization to associate one of one or more delegates, designated by the customer, to receive products on behalf of the customer; a delegate tracking system configured to identify when a first delegate of the one or more delegates is within a geographic threshold distance of an originally specified receiving location where the product ordered by the customer is scheduled to be received; and a delivery authorization system configured to communicate an authorization to a first user interface unit associated with the first delegates that authorizes the first delegate to receive the product at the receiving location on behalf of the customer.

Further, some embodiments provide methods of controlling product delivery, comprising: receiving, from a customer who ordered a product, an authorization to associate one of one or more delegates, designated by the customer, to receive products on behalf of the customer; identifying when a first delegate of the one or more delegates is within a geographic threshold distance of an originally specified receiving location where the product ordered by the customer is scheduled to be received; and communicating an authorization to a first user interface unit associated with the first delegate that authorizes the first delegate to receive the product at the receiving location on behalf of the customer.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A product delivery control system, comprising:
a customer authorization system configured to receive, from a customer who ordered a product, an authorization to associate one of one or more delegates, designated by the customer, to receive products on behalf of the customer;
a delegate tracking system configured to identify when a first delegate of the one or more delegates is within a geographic threshold distance of an originally specified receiving location where the product ordered by the customer is scheduled to be received; and
a delivery authorization system configured to communicate an authorization to a first user interface unit associated with the first delegates that authorizes the first delegate to receive the product at the receiving location on behalf of the customer.

2. The delivery control system of claim 1, wherein the delegate tracking system is further configured to repeatedly receive over time global positioning information from user interface units, including the first user interface unit, associated with each of the one or more previously designated delegates, and in identifying that the first delegate is within the threshold distance is further configured to identify one or more user interface units, based on the global positioning information, that are within the geographic threshold distance of the receiving location at a time corresponding to when the product is to be received.

3. The delivery control system of claim 2, wherein the delivery authorization system is further configured to receive a notification that the customer is not going to be available at the receiving location to retrieve the product; and
wherein the delegate tracking system is further configured to identify that the first delegate is associated with the customer as one of the one or more delegates, and to evaluate a most recent global positioning information from the first user interface unit, of the global positioning information received over time, relative to the receiving location in response to receiving the notification that the customer is not going to be available at the receiving location to retrieve the product and that the first delegate is associated with the customer as one of the one or more delegates.

4. The delivery control system of claim 1, wherein the delivery authorization system is further configured to receive a notification that the customer is not going to be available at the receiving location at a scheduled delivery time to retrieve the product, wherein the delivery authorization system communicates the authorization to the first user interface unit associated with the first delegate in response to receiving the notification that the customer is not going to be available at the receiving location and the first user interface unit is within the geographic threshold distance of the receiving location.

5. The delivery control system of claim 1, wherein the delegate tracking system is further configured to identify, when the receiving location is at a shopping facility from which the customer requested the first product be retrieved, that the first delegate is within the geographic threshold distance of the shopping facility; and to notify the customer that at least one of the one or more delegates designated by the customer is within the geographic threshold of the shopping facility.

6. The delivery control system of claim 1, wherein the delegate tracking system is further configured to identify, when the receiving location is at a scheduled delivery address where a delivery vehicle is scheduled to deliver the product, that the first delegate is within the geographic threshold distance of the scheduled delivery address; and to notify the customer that at least one of the one or more delegates designated by the customer is within the geographic threshold of the scheduled delivery address.

7. The delivery control system of claim 6, wherein the delivery authorization system is further configured to notify delivery personnel associated with the delivery vehicle that the first delegate is authorized to receive the product at the originally specified receiving location on behalf of the customer and that the authorization has been communicated to the first user interface unit.

8. The delivery control system of claim 1, wherein the delegate tracking system is further configured to:
communicate a request to at least the first delegate requesting an acknowledgment that the first delegate is willing to receive the first product on behalf of the customer; and
notify the customer that the at least one of the one or more delegates is within the geographic threshold of the receiving location in response to receiving an acknowledgement from the first delegate that the first delegate is willing to receive the first product on behalf of the customer.

9. A method of controlling product delivery, comprising:
receiving, from a customer who ordered a product, an authorization to associate one of one or more delegates, designated by the customer, to receive products on behalf of the customer;
identifying when a first delegate of the one or more delegates is within a geographic threshold distance of an originally specified receiving location where the product ordered by the customer is scheduled to be received; and
communicating an authorization to a first user interface unit associated with the first delegate that authorizes the first delegate to receive the product at the receiving location on behalf of the customer.

10. The method claim 9, further comprising:
repeatedly receiving over time global positioning information from user interface units, including the first user interface unit, associated with each of the one or more previously designated delegates; and
wherein the identifying that the first delegate is within the threshold distance further comprises identifying one or more user interface units, based on the global positioning information, that are within the geographic threshold distance of the receiving location at a time corresponding to when the product is to be received.

11. The method of claim 10, further comprising:
receiving a notification that the customer is not going to be available at the receiving location at a scheduled delivery time to retrieve the product;
identifying that the first delegate is associated with the customer as one of the one or more delegates; and
evaluating a most recent global positioning information from the first user interface unit, of the global positioning information received over time, relative to the receiving location in response to receiving the notification that the customer is not going to be available at the receiving location to retrieve the product and that the first delegate is associated with the customer as one of the one or more delegates.

12. The method of claim 9, further comprising:
receiving a notification that the customer is not going to be available at the receiving location to retrieve the product; and
communicating the authorization to the first user interface unit associated with the first delegate in response to receiving the notification that the customer is not going to be available at the receiving location and the first user interface unit is within the geographic threshold distance of the receiving location.

13. The method of claim 9, further comprising:
identifying, when the receiving location is at a shopping facility from which the customer requested the first product be retrieved, that the first delegate is within the geographic threshold distance of the shopping facility; and
notifying the customer that at least one of the one or more delegates designated by the customer is within the geographic threshold of the shopping facility.

14. The method of claim 9, further comprising:
identifying, when the receiving location is at a scheduled delivery address where a delivery vehicle is scheduled to deliver the product, that the first delegate is within the geographic threshold distance of the scheduled delivery address; and
notifying the customer that at least one of the one or more delegates designated by the customer is within the geographic threshold of the scheduled delivery address.

15. The method of claim 14, further comprising:
notifying delivery personnel associated with the delivery vehicle that the first delegate is authorized to receive the product at the originally specified receiving location on behalf of the customer and that the authorization has been communicated to the first user interface unit.

16. The method of claim 9, further comprising:
communicating a request to at least the first delegate requesting an acknowledgment that the first delegate is willing to receive the first product on behalf of the customer; and
notifying the customer that at least one of the one or more delegates is within the geographic threshold of the receiving location in response to receiving an acknowledgement from the first delegate that the first delegate is willing to receive the first product on behalf of the customer.
